(19) United States
(12) Patent Application Publication
(10) Pub. No.: US 2026/0264028 A1
(43) Pub. Date: Sep. 10, 2026

(54) HYDROGEN INFUSED DRINKING SYSTEM

(71) Applicant: Taryn Lee Harrington, East Perth (AU)

(72) Inventor: Taryn Lee Harrington, East Perth (AU)

(21) Appl. No.: 19/339,120

(22) Filed: Sep. 24, 2025

Related U.S. Application Data
(60) Provisional application No. 63/702,776, filed on Oct. 3, 2024.
(60) Provisional application No. 63/816,452, filed on Jun. 2, 2025.

(51) Int. Cl. B01F 23/23; B01F 23/237; B01F 35/21; B01F 35/22; B01F 101/14

(52) U.S. Cl. CPC B01F 23/2368; B01F 23/2319; B01F 23/23764; B01F 23/238; B01F 35/2132; B01F 35/2202; B01F 2101/14

(57) ABSTRACT

A hydrogen-infusing container is described in which the drinking fluid is exposed to both electromagnetic energy and magnetic fields while hydrogen is introduced. The system includes a non-visible electromagnetic frequency generator, such as infrared, ultraviolet, or ultrasonic sources, and at least one magnet arranged to simulate natural environmental conditions. The combination stabilizes the infused hydrogen, promotes nanobubble formation, and supports user-selectable conditioning modes. Control circuitry and sensors may adjust energy output to maintain desired liquid characteristics.

### RELATED APPLICATIONS

This application claims the benefit of U.S. Provisional Patent Application No. 63/702,776, entitled “H2 Water Bottle”, filed on Oct. 3, 2024, and U.S. Provisional Patent Application No. 63/816,452, entitled “Hydrogen Infused Drinking System”, filed on Jun. 2, 2025, the entire contents of each of which are incorporated herein by reference.

### BACKGROUND

### a. Field of the Inventions

embodiments of the present inventions relate to hydrogen infused drinking systems.

### b. Background of the Inventions

c. Drinking hydrogen-infused water has significant health benefits. However, challenges remain in the design and development of systems for conveniently and safely producing and providing hydrogen water.

### SUMMARY OF THE INVENTIONS

The present invention provides a summary of various aspects of the inventive subject matter. This summary is not intended to be exhaustive, nor is it intended to limit the invention to the precise forms disclosed. Rather, it is intended to introduce, in simplified form, some concepts that are further described in the Detailed Description. The invention may be embodied in many different forms and should not be construed as limited to the embodiments set forth herein.

In accordance with embodiments of the invention, a hydrogen-infusing beverage container is provided. The container is formed with a vessel that defines a drinking-fluid chamber. A hydrogen-generation compartment is included and is isolated from the drinking-fluid chamber. The hydrogen-generation compartment is provided with an electrolysis cell that is configured to produce hydrogen gas. A pressure-actuated one-way valve fluidly couples the hydrogen-generation compartment to an intermediate pressurized chamber positioned downstream of the valve. A porous mesh is disposed between the intermediate pressurized chamber and the drinking-fluid chamber, and the mesh is provided with pores sized to fragment hydrogen gas passing therethrough into fine bubbles. A mixing assembly may be located in the drinking-fluid chamber and is formed with an impeller carrying a magnetic element, together with an array of stationary electromagnets positioned outside the drinking-fluid chamber. The electromagnets are arranged to be sequentially energized to create a rotating magnetic field that rotates the impeller. Control circuitry is operatively coupled to the electrolysis cell, optionally the one-way valve when electrically activated, and the array of electromagnets. In operation, hydrogen gas generated in the hydrogen-generation compartment is accumulated until a threshold pressure opens the one-way valve, after which the gas flows into the intermediate pressurized chamber, passes through the porous mesh as fine bubbles into the drinking-fluid chamber, and is dispersed throughout the drinking fluid by fluid motion created through rotation of the impeller.

In certain embodiments, the porous mesh is formed of a sintered ceramic material having an average pore diameter between about 1 μm and 50 μm. In some versions, the porous mesh is removably mounted so that cleaning or replacement is permitted without disassembly of the hydrogen-generation compartment. The one-way valve may be configured to open at a pressure between about 5 psi and 25 psi above the ambient pressure within the drinking-fluid chamber. The array of stationary electromagnets may include at least three phase-shifted coils spaced circumferentially about an axis of the impeller. The control circuitry may be arranged to sequentially energize the electromagnets with pulse-width-modulated drive signals so that the impeller is maintained at a selected rotational speed.

In some embodiments, the impeller is positioned coaxially below the porous mesh so that a vortex induced by the impeller draws fine hydrogen bubbles downward before they rise toward the fluid surface. The impedance of the porous mesh and the rotational speed of the impeller may be selected so that at least 80 percent of the hydrogen gas mass dissolves into the drinking fluid within 60 seconds after a valve-opening event. A rechargeable battery may be housed within a sealed base of the vessel and electrically coupled to power the electrolysis cell and the array of electromagnets. The vessel may further be provided with a user interface that allows selection among at least two mixing modes having different impeller speeds. The control circuitry may de-energize the array of stationary electromagnets when a fill-level sensor indicates that the drinking-fluid chamber is empty.

The drinking-fluid chamber may be sized to hold between about 200 mL and 1 L of potable liquid. The electrolysis cell may be powered with pulse-width-modulated current having a duty cycle selected to limit the temperature rise of the hydrogen-generation compartment to less than 10° C. above ambient. An overpressure vent may be coupled to the intermediate pressurized chamber and configured to release gas to atmosphere if pressure exceeds a predetermined safety threshold. In certain embodiments, the vessel is constructed with an inner polymer liner and an outer structural sleeve, with the hydrogen-generation compartment being integrally molded with the inner polymer liner.

In another embodiment, a hydrogen-infusing beverage container is provided in which the drinking-fluid chamber is arranged about a generally vertical central axis. A hydrogen-generation compartment is located along the central axis and is configured to generate hydrogen gas. A pressure-actuated one-way valve fluidly couples the hydrogen-generation compartment to the drinking-fluid chamber. A porous mesh is positioned downstream of the valve and coaxial with the central axis, and the porous mesh is sized to fragment hydrogen gas into fine bubbles. An impeller is mounted within the drinking-fluid chamber at a location laterally offset from the central axis. A drive assembly is operatively coupled to the impeller and is arranged to rotate the impeller about an impeller axis spaced radially from the central axis. Control circuitry is configured to actuate the hydrogen-generation compartment to create hydrogen gas, open the one-way valve when a threshold pressure is reached, and energize the drive assembly such that rotation of the offset impeller establishes a flow pattern that draws fine bubbles inward toward the central axis and upward toward the fluid surface.

The drive assembly may be formed with an array of stationary electromagnets disposed outside the drinking-fluid chamber and sequentially energized to create a rotating magnetic field that couples to a magnetic element carried by the impeller. Alternatively, the drive assembly may be formed with a miniature electric motor having an output shaft sealed by a fluid-tight bearing that directly rotates the impeller. In certain implementations, the array of stationary electromagnets may include at least three phase-shifted coils arranged circumferentially around the impeller axis. In some versions, the offset impeller is housed in a side recess formed in a wall of the vessel, with the recess opening into the drinking-fluid chamber through an arcuate aperture sized to allow fluid exchange while preventing impeller contact with objects inserted by a user. One or more flow-guide baffles may be positioned adjacent the impeller and shaped to deflect an initial tangential jet toward the central axis.

The control circuitry may be configured to energize the drive assembly at a first, higher rotational speed for a predetermined interval immediately after each valve-opening event and thereafter maintain the impeller at a lower maintenance speed. The impeller axis may be spaced at least 10 mm from the central axis and no more than 30 percent of an inner diameter of the vessel. Rotation of the offset impeller may generate a vortex that originates near an interior sidewall, spirals inward toward the central axis, and self-centers near the fluid surface. In certain embodiments, the porous mesh is removable for cleaning and is installed in a carrier that snaps into an annular seat coaxial with the central axis.

The drive assembly may be powered by a rechargeable battery that also powers the hydrogen-generation compartment, the battery being housed within a sealed base portion of the vessel. The control circuitry may include a dissolved-hydrogen concentration sensor and adjust impeller speed based on sensor output to maintain a target hydrogen concentration. The drive assembly and impeller may be configured to operate at a sound pressure level not exceeding 45 dBA at a distance of 0.3 meters. A user-selectable mode may be included in which the drive assembly rotates the impeller in alternating clockwise and counter-clockwise directions to prevent bubble coalescence on the vessel's interior surfaces. The porous mesh may have an average pore diameter between about 2 microns and 25 microns, and the control circuitry may coordinate hydrogen-generation duty cycle and impeller rotation so that at least 75 percent of the generated hydrogen dissolves into the fluid within 90 seconds of valve opening.

It should be understood that the foregoing summary is provided to introduce in a simplified form certain concepts that are further described in the Detailed Description. The summary is not intended to identify key or essential features of the claimed subject matter, nor is it intended to be used as an aid in determining the scope of the claimed subject matter. The invention will be understood more fully from the following description and the appended claims.

### BRIEF DESCRIPTION OF THE FIGURES

Reference will now be made to the accompanying drawings, which are included to provide a further understanding of the invention and are incorporated in and constitute a part of this specification. The drawings illustrate embodiments of the invention and, together with the description, serve to explain principles of the invention. It should be understood that the drawings are not necessarily to scale, and that certain features may be exaggerated or simplified for clarity of illustration.

FIG. 1 illustrates a drinking bottle in accordance with the principles of the present invention.

FIG. 2 illustrates a valve system in accordance with the principles of the present invention.

FIG. 3 illustrates a valve system in accordance with the principles of the present invention.

FIG. 4 illustrates a diffusion system in accordance with the principles of the present invention.

FIG. 5 illustrates a hydrogen infusion system illustrates a valve system in accordance with the principles of the present invention.

FIG. 6 illustrates a purification system illustrates a valve system in accordance with the principles of the present invention.

FIG. 7 illustrates a hydrogen infusion system with an active mixer illustrates a valve system in accordance with the principles of the present invention.

FIG. 8 illustrates a control system for hydrogen infusion illustrates a valve system in accordance with the principles of the present invention.

### DETAILED DESCRIPTION

The following detailed description is provided to enable a person skilled in the art to make and use the inventions and is presented in the context of particular embodiments. Various modifications to the described embodiments will be readily apparent to those skilled in the art, and the general principles defined herein may be applied to other embodiments and applications without departing from the scope of the inventions. Thus, the inventions are not intended to be limited to the embodiments shown, but is to be accorded the widest scope consistent with the principles and features disclosed herein.

The inventors discovered a new way to generate hydrogen water and maintain its purity. The inventors discovered that conventional hydrogen water production and/or infusion can lead to contamination of the drinkable water/solution. Diffusing hydrogen directly into the drinking water from a hydrogen generating source may infuse by-products of the hydrogen generation process into the water.

In embodiments, a water system in accordance with the principles of the present inventions may take the form of a handheld water bottle that has ready to drink water or another beverage of choice that is hydrogen infused with a hydrogen generator in the water bottle. The system may have two or more compartments separating a hydrogen generator from the drinkable solution such that there is little to no mixing of fluids from the generation compartment with the drinkable water/solution compartment.

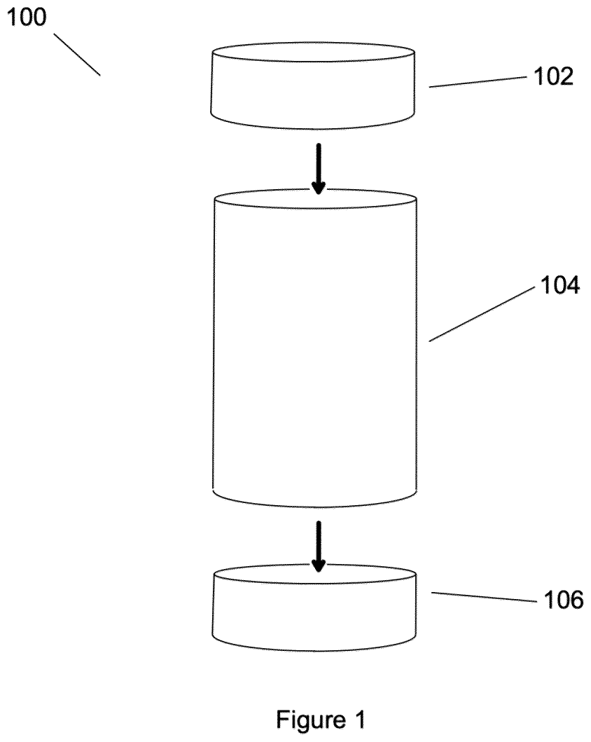

FIG. 1 illustrates a multi-compartment hydrogen generating water bottle 100. The water bottle 100 includes a removable hydrogen generation compartment 106 where a hydrogen generator may be enclosed. A hydrogen generator may include an electrolysis system to generate hydrogen from water in the compartment, metals/chemicals (e.g., aluminum, magnesium, metal hydrides, nano-silicone) to react with water in the compartment to generate hydrogen, etc. The hydrogen generation compartment 106 may be watertight such that it can hold water while also preventing water from leaving the compartment. While it may be watertight, it may also be designed to allow generated hydrogen to pass out of the hydrogen generation compartment 106 into a drinking water compartment. The water bottle 100 may also have a removable top 102 that provides a hermetic gas seal when secured.

Water bottle 100 may also include a drinkable water compartment 104 and a removable cover. The seals between the different compartments and the cap may further be sealed to prevent or minimize leakage of hydrogen. The drinkable water/solution compartment 104 may be mechanically attached to the hydrogen generation compartment 106 to receive generated hydrogen and build up hydrogen pressure in the water compartment. Hydrogen passing through the water, from the hydrogen generation compartment 106, may diffuse into the water/solution causing the water/solution to become hydrogen rich. The drinkable water/solution compartment may also have space for hydrogen pressure build up for hydrogen that does not dissolve into the water as it passes through the water. For example, there may be an air gap left at the top of the drinkable water compartment to collect hydrogen. The hydrogen may then diffuse into the water until an equilibrium is established between the hydrogen pressure in the air gap and the water/solution.

Another aspect of the present inventions relates to systems and methods used to infuse hydrogen from the generation compartment 106 to the drinking compartment 104. A feature of some of the infusion methods include systems and methods that pass hydrogen but prevent water from the generation compartment 106 to the drinking compartment 104. Such arrangements may prevent contaminants from the hydrogen generation process from entering the drinking water.

Hydrogen-enriched drinking water has gained popularity due to potential health benefits associated with the ingestion of dissolved molecular hydrogen (H₂). Conventionally, such hydrogen is produced at the point of use through electrolysis, wherein water is split into hydrogen and oxygen gases. These systems often involve electrodes, membranes, and other components that can degrade or leach contaminants—such as metal ions or particulates—into the water during operation.

The inventor has recognized that conventional hydrogen generation systems pose a contamination risk due to the proximity of the electrolysis process to the drinking water compartment. In particular, waste materials—including metallic debris or byproducts of electrode degradation—may migrate into the drinking water along with the generated hydrogen gas. This risk is exacerbated in systems where the hydrogen gas is allowed to pass freely from the generation chamber into the drinking water chamber without sufficient physical separation or isolation.

To address these and other deficiencies, the inventor has developed a dual-chamber hydrogen-infusing drinking bottle. The design includes a hydrogen generation chamber and a separate drinking water chamber, with a selective, pressure-activated valve that controls the release of hydrogen gas while minimizing the risk of contamination. In some embodiments, a membrane is positioned in line with the valve to provide additional separation or filtration, but the membrane does not control the opening or closing of the gas pathway.

The system is configured such that the hydrogen generator forms a gas bubble that grows to fill an outlet port, physically distancing any waste or contaminants from the exit point. Once sufficient pressure builds, the valve selectively opens to release the pressurized hydrogen bubble into the drinking water compartment. This release is momentary, after which the valve re-closes, isolating the hydrogen generation chamber from the drinking water. The process may repeat cyclically: each new bubble forms, pushes any accumulated waste away from the exit, and is released through the same sealed mechanism. This results in a self-cleansing action at the interface between the generator and the drinking water, thereby maintaining a clean gas delivery path.

This inventive approach improves the safety and purity of hydrogen-infused drinking water by introducing a novel mechanical separation and bubble-mediated release system that reduces or eliminates the migration of contaminants from the hydrogen generator into the water intended for consumption.

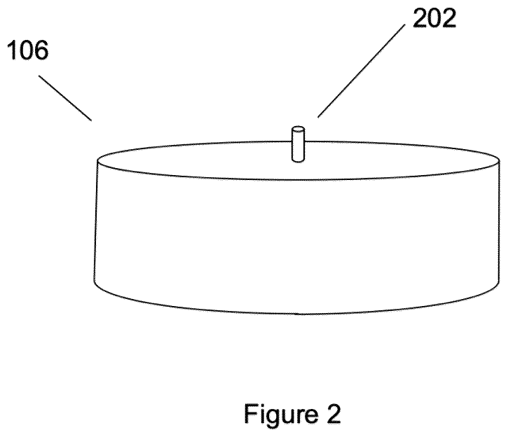

FIG. 2 illustrates a hydrogen generation compartment 106 with a pressure activated valve 202. The pressure activated valve 106 may be a mechanical device, electromechanical device, etc. It may operate as a check valve to allow flow from the hydrogen generation compartment 106 into the drinking water when the hydrogen pressure in the hydrogen generation compartment 106 reaches a set point. For example, the pressure activated valve may be a 3 mm one-way plastic check valve with an inlet activation pressure, to open the valve, ≈0.5 Kpa with a maximum backpressure of 300 Kpa.

As the hydrogen generator operates in the hydrogen generation compartment 106 the pressure in the hydrogen generation compartment 106 will rise. Once the pressure reaches the threshold (e.g., 0.5 Kpa) the check valve opens and allows the built-up pressure to escape the hydrogen generation compartment 106 and enter the drinking water/solution compartment 104. The hydrogen will collect at the top of the hydrogen generation compartment 106 and opening of the check valve may release the hydrogen into the drinking water. Once the pressure in the hydrogen generation compartment 106 is relieved, the check valve may close preventing any cross contamination of fluids between the two compartments.

Another aspect of the present inventions relates to aligning hydrogen collection in the hydrogen generation compartment 106 with the gas passageway (e.g., pressure valve 202). To encourage the generated hydrogen to collect near a gas exit of hydrogen generation compartment 106 a small gap may be included in the pressure valve 202 on the hydrogen generation compartment 106 and gas may then collect in the gap such that the gas creates a buffer zone between the valve's gate and the water within the hydrogen generation compartment 106. When the gate opens, the gas bubble can escape with no or little fluid. In embodiments, the water bottle 100 may include a tip sensor to measure the vertical angle of the water bottle 100. This measure may be used to turn on and off the hydrogen generation or valve actions such that hydrogen is only generated with the water bottle is substantially in an upright position.

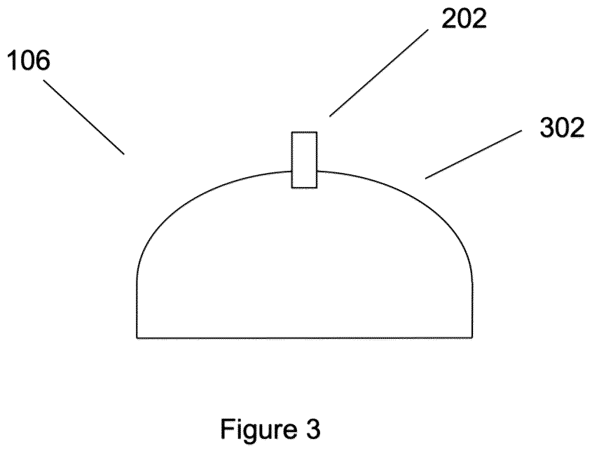

FIG. 3 illustrates a hydrogen generation compartment 106 with a curved upper internal surface 302. The curved upper internal surface 302 may be included to further encourage the development of a gas gap near the exit of the pressure valve.

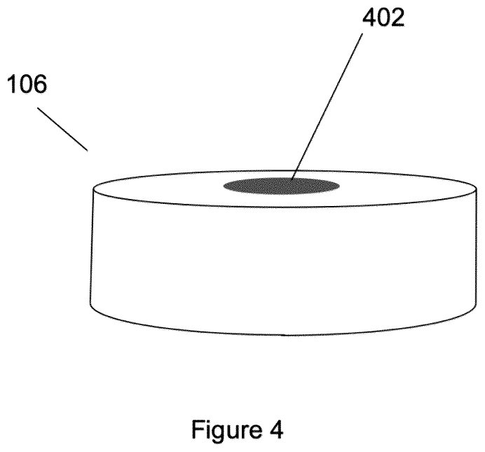

Another aspect of the present inventions relates to the use of a membrane (hydrophobic or hydrophilic). As illustrated in FIG. 4, instead of or in addition to a pressure valve 202, the hydrogen generation compartment 106 may include a membrane 402 separating the hydrogen generation compartment 106 from the drinkable water/solution compartment 104. The membrane 402 may pass the generated hydrogen gas from the hydrogen generation compartment 106 into the drinkable water/solution compartment 104 while preventing fluid exchange between the compartments.

The use of a one-way valve to reduce contamination introduced a new challenge. The hydrogen bubbles produced and released by the system are relatively large. As these bubbles rise through the drinking water, only a portion of the hydrogen is absorbed. The rest accumulates at the top of the bottle as a headspace of unabsorbed gas. While this gas will eventually dissolve into the water as pressure equilibrates, the absorption rate is slow—slower than desired for consumer use. Many users wish to consume the hydrogen-rich water shortly after generation, and the delay caused by poor absorption undermines that goal.

To address this, the inventor developed a secondary enhancement: a two-stage delivery mechanism. In some embodiments, after the valve opens, the hydrogen bubble first enters an intermediate chamber before reaching the drinking water. This second chamber is configured with a porous filter—such as a ceramic mesh or other ultra-fine pore material—that disperses the bubble into much smaller bubbles as pressure builds. These smaller bubbles offer significantly improved surface-area-to-volume ratios, enabling faster and more complete dissolution of hydrogen into the drinking water.

This dual-solution approach—physical separation to block contaminants and controlled bubble fragmentation to accelerate absorption—results in a system that delivers high-purity, hydrogen-enriched water more quickly and reliably than prior designs.

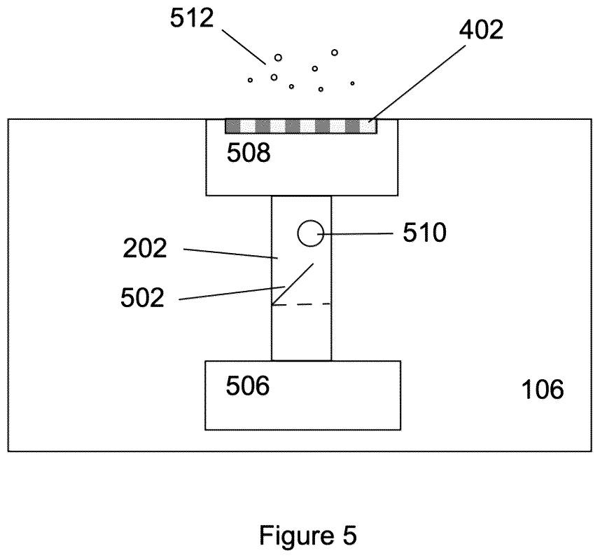

FIG. 5 illustrates a two-stage hydrogen delivery system for a dual-chamber drinking bottle, designed to reduce contamination and improve hydrogen gas absorption into the drinking water.

Hydrogen gas is generated in a hydrogen generation compartment (106) by a hydrogen generator (506). Hydrogen gas accumulates within the generation compartment below the closed pressure activated valve 202. The pressure valve is shown in the operational states of open and closed 502 for illustrative purposes. Once sufficient pressure has built, the pressure valve (202) opens, allowing the large hydrogen bubble (510) to move upward into an upper stage chamber (508). Located at the top of the upper stage chamber is a fine porous material (e.g., membrane (402), ceramic). The porous medium allows hydrogen to pass through under a pressure differential as the pressure builds in the lower chamber. As the gas moves through the porous material, it is forced into small hydrogen bubbles (512).

These smaller bubbles then enter the drinking water compartment (not shown in this figure), where they dissolve more efficiently due to their increased surface-area-to-volume ratio. This staged approach allows the system to maintain a physical separation between the hydrogen generation area and the drinking water, while enhancing hydrogen absorption performance through bubble size reduction.

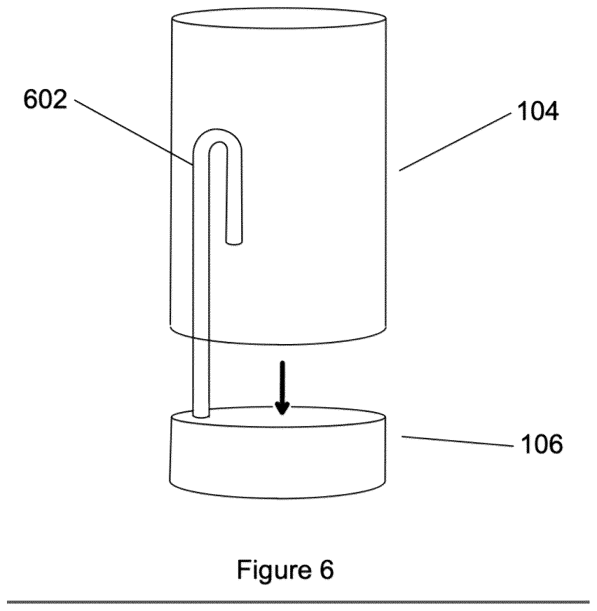

FIG. 6 illustrates another aspect of the present invention relates to providing pathways for the hydrogen that is generated in the hydrogen generation compartment 106 to pass into the drinkable water/solution compartment 104. In embodiments, a curved tube 602 enters the hydrogen generation compartment 106 to provide the generated hydrogen an exit into the drinkable water compartment 104. The curved tube 602 may be curved to reverse its direction from generally upward, with the bottle substantially upright, to generally downward. This may prevent contaminants from the hydrogen generation compartment 106 from entering the drinkable water compartment 104. It functions to infuse the generated hydrogen while allowing contaminants to sink and stay in the hydrogen generation compartment 106. In embodiments, if the hydrogen generator stops operating or the hydrogen pressure is not enough to prevent water from flowing back into the curved tube 602, a valve (e.g., pressure valve, electromechanical valve) may be activated to seal the curved tube 602.

Another aspect of the present invention relates to providing pathways for the generated hydrogen to pass into the drinkable water using pressure sensing and mesh to make micro-bubbles. Smaller bubbles absorb more quickly than larger bubbles, and the inventors discovered that a pressure valve may work well to keep contaminates out of the drinking water, but the pressure valve may not be small enough to make small bubbles. In embodiments, the pressure valve releases the generated hydrogen to a mesh (e.g. membrane) such that the larger bubbles are forced into smaller bubbles while passing through the mesh.

The inventor further discovered that, in addition to or as an alternative to the two-stage hydrogen delivery system described above, the rate of hydrogen absorption into the drinking water can be significantly enhanced by actively mixing or agitating the water. In various embodiments, the bottle may therefore include one or more systems configured to induce water movement, thereby promoting faster dissolution of hydrogen gas. These systems may include, for example, a mechanical mixing element, a vortex generator, an ultrasonic wave generator, a low-frequency acoustic wave generator, or a magnetic spinner positioned to stir the water within the chamber. In some embodiments, a water pump may be included to circulate water either within the drinking water chamber or between the drinking water chamber and an adjacent compartment, thereby enhancing fluid dynamics and gas-liquid interaction. In additional embodiments, a dedicated gas pump may be used to draw hydrogen gas from the headspace of the drinking water chamber and inject it back into the water through a submerged outlet. This outlet may include a tube or conduit extending into the water, optionally composed of or containing a bamboo-based material to promote hydrogen absorption. These enhancements allow the system to maximize hydrogen dissolution and reduce wait times for consumption, further improving the functionality and user experience of the hydrogen-infusing bottle.

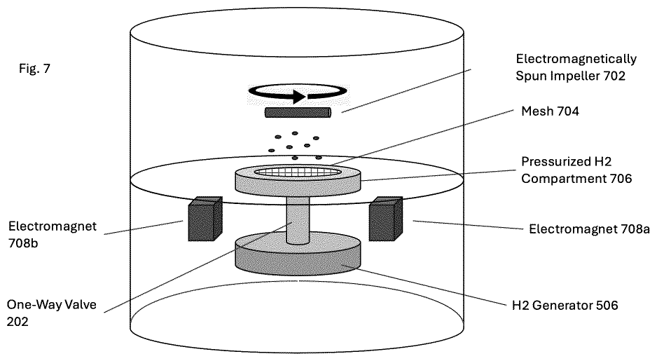

FIG. 7 illustrates, in cross-section, a two-stage hydrogen-delivery architecture that couples bubble fragmentation with active fluid mixing to accelerate dissolution of molecular hydrogen while physically isolating the electrolysis by-products. A hydrogen generator 506 produces hydrogen gas that rises until the pressure at a normally-closed one-way valve 202 exceeds a calibrated threshold. When the valve opens, the gas flows into a downstream pressurized compartment 706 rather than directly into the drinking water, thereby preserving a barrier between any solid or ionic waste in the generator and the water destined for consumption. Within compartment 706 the hydrogen immediately encounters a porous mesh 704—for example, a sintered ceramic disc or stainless-steel frit sized to create micron-scale passages. The pressure differential across the mesh forces the gas through these pores, shearing the large upstream bubble into a cloud of fine bubbles that emerge on the downstream face and enter the drinking-water region.

To ensure those fine bubbles dissolve rapidly instead of coalescing at the surface, an impeller 702 is positioned in the lower portion of the water chamber. The impeller contains an embedded magnetic element (e.g., a bar magnet or diametrically-magnetised disc) and is driven entirely without mechanical penetration of the bottle wall. Beneath the chamber, a plurality of stationary electromagnets—labelled 708a, 708b, and, in alternative embodiments, 708c, 708d, etc.—are arranged circumferentially. By sequentially energising these coils with phase-shifted drive signals (dual-phase, three-phase, or higher-order multi-phase commutation), the control circuitry generates a rotating magnetic field that magnetically couples to the impeller and causes it to spin at hundreds of revolutions per minute. This rotation produces a stable downward vortex that continuously circulates the bulk liquid, drags the fine bubbles into the body of the water, renews the liquid-gas interface, and thereby markedly shortens the time required for the hydrogen to dissolve.

The electromagnetic drive array may be realised as discrete wire-wound bobbin coils, planar PCB spiral coils, or laminated voice-coil rings, and can be pulse-width-modulated to balance torque, power consumption, and thermal rise. Likewise, the impeller may take the form of a magnetic stir bar, a bladed propeller mounted on low-friction pivots, or a vane cup configured to ride on a hydrodynamic bearing. In all such variants, the cooperating elements—the pressure-gated valve, the bubble-fragmenting mesh, and the magnetically driven mixer—operate in concert to keep contaminants upstream, to produce small, highly soluble hydrogen bubbles, and to maintain vigorous mixing that maximises hydrogen uptake for immediate consumption.

In another embodiment, the mixing element is positioned laterally with respect to the hydrogen-generation pathway, rather than concentrically below it as depicted in FIG. 7. Here, the hydrogen generator 506, one-way valve 202, pressurised compartment 706, and mesh 704 remain substantially as previously described, aligned along a primary central axis that delivers finely divided hydrogen bubbles into the drinking-water region. An impeller 720 is instead mounted adjacent to an interior sidewall of the drinking-water chamber, occupying a recess or shelf that does not interfere with the gas-delivery line. Because the impeller sits off-axis, the vortex it initiates originates near the sidewall, curves inward, and ultimately centres near the free surface of the liquid; this spiral trajectory sweeps a larger portion of the chamber volume and has been observed to pull bubbles away from the walls before channelling them toward the central plume, thereby improving dispersion and mitigating dead-zone stratification.

The impeller may be magnetically driven by a peripheral array of electromagnets (e.g., 721a, 721b, 721c), pulsed in sequence to create a rotating field that couples to a magnetic element embedded in the impeller hub. The coil set can be dual-phase, three-phase, or higher-order, depending on available board area and desired torque profile. Alternatively, the impeller can be driven by a miniature sealed electric motor (723) whose output shaft penetrates the bottle wall through a fluid-tight bearing or, in another variant, magnetically couples through the wall via coaxial face magnets to eliminate dynamic seals. In either implementation the impeller blades are oriented to launch an initially tangential jet, establishing the off-center vortex that migrates toward the vessel axis as it ascends.

Baffles or flow-guide vanes (optional) may be molded into the sidewall near the impeller to shape the emerging swirl and to prevent recirculating eddies from short-circuiting the bubble plume. The offset arrangement also frees the bottom-center real estate for larger electrodes, thicker insulation, or additional sensors—such as optical turbidity detectors or thermistors—without increasing overall bottle height. Moreover, by relocating the impeller's drive hardware away from the hydrogen path, potential electromagnetic interference with electrolysis control circuitry is reduced, and maintenance access to the mixer components is simplified.

This offset-impeller configuration therefore offers a packaging-flexible and hydraulically efficient alternative that can be tuned—via impeller diameter, rotational speed, and sidewall geometry—to optimize bubble entrainment and hydrogen dissolution for form factors in which the concentric stacking of FIG. 7 is impractical.

In yet another embodiment, both the porous mesh and the intermediate pressurized compartment are omitted, leaving a simplified pathway in which hydrogen travels directly from the generator into the drinking water. A hydrogen generator 506 located at the bottom of the bottle produces gas that accumulates behind a one-way valve 202 positioned immediately at the outlet of the generator chamber. When the pressure of the forming bubble exceeds the valve's opening threshold, the valve lifts and the intact, larger-volume bubble moves straight into the drinking-water region. Because no separate holding space exists downstream of the valve, each cycle transfers gas the moment the valve opens, minimizing flow resistance and component count.

Although the bubbles enter at full size, they are rapidly re-circulated by an active mixing system. Depending on packaging constraints, the bottle may employ (i) a centrally located magnetic stir bar driven by a planar coil array under the base, (ii) an off-axis impeller 720 coupled to a compact side motor 723, or (iii) a low-frequency acoustic transducer bonded to the wall. Each mixer is controlled to engage immediately after a valve event, imparting turbulence that forces the large bubble to break up through shear or to follow an elongated spiral path that maximizes its contact time with the liquid before it reaches the surface. If an offset impeller is used, the initial vortex forms near the sidewall, sweeps the bubble cloud inward, and funnels it toward the centerline, ensuring thorough dispersion even in tall or irregularly shaped vessels.

Removing the pressurized compartment and mesh simplifies manufacturing, eliminates potential clogging sites, and lowers the pressure set-point required for valve actuation, thereby reducing electrolysis current draw and heat generation. The direct-bubble approach also shortens the latency between gas production and infusion, allowing the control firmware to trigger rapid, frequent charge cycles that keep the dissolved-hydrogen concentration consistently high while preserving the contamination barrier afforded by the valve.

In a further embodiment, the rotary impeller described in the preceding configurations is replaced by a non-rotary mixing assembly that produces bulk fluid movement without necessarily forming a coherent vortex. A representative implementation employs one or more oscillating or reciprocating elements—collectively designated mixing element 740—mounted inside the drinking-water chamber. Each element may take the form of a thin, paddle-like vane, a flexible diaphragm, or a beam that pivots about an integral hinge. An electromagnetic linear actuator 742 (for example, a miniature voice-coil or solenoid) or a piezoelectric stack periodically drives the element through a short stroke, imparting pulses of momentum to the surrounding water. The stroking cycle can be programmed at frequencies from a few hertz to several hundred hertz; lower frequencies create large-scale sloshing that sweeps bubbles along complex paths, while higher frequencies generate micro-eddies that fracture bubbles and thin the diffusion boundary layer.

Multiple elements may be arrayed at different heights or azimuths—e.g., upper and lower paddles that oscillate 180 degrees out of phase—to set up counter-circulating flow loops that wash the entire volume without requiring a vortex core. In another variant, two or more diaphragms on opposite walls pulse alternately, creating a peristaltic “breathing” motion that repeatedly compresses and expands the liquid column, thereby distributing gas pockets uniformly. Because no rotating shaft or large radial clearances are needed, the non-rotary mixer can be molded as an integral part of the bottle liner or clipped onto interior rails, freeing space at the base for larger batteries or additional sensing electronics.

The control firmware coordinates mixer actuation with the hydrogen-generation cycles: a brief burst of rapid oscillations is triggered immediately after each valve opening to shred incoming bubbles, followed by a lower-duty maintenance pattern that keeps dissolved-gas concentration homogeneous. Power consumption is comparable to, or lower than, that of a rotary impeller because the drive coil is energized only during short stroke intervals. Moreover, the absence of rotating parts reduces mechanical wear and eliminates startup torque constraints, making this non-vortex agitation embodiment particularly attractive for compact bottle geometries or applications requiring ultra-quiet operation while still achieving rapid hydrogen dissolution.

In still another embodiment, bulk fluid motion and bubble fragmentation are produced not by mechanical stirring elements but by acoustic energy injected into the drinking-water chamber. A piezoelectric or electromagnetic transducer 750 is coupled to the bottle wall or base and is driven by an audio-frequency amplifier under microcontroller supervision. Two principal operating regimes are contemplated:

### Ultrasonic Mixing (≈20 kHz- 1 MHz).

A piezoelectric disc bonded to the underside of the water compartment converts high-frequency electrical oscillations into longitudinal pressure waves. At sufficiently high amplitude the waves generate cavitation micro-bubbles that collapse violently, creating localized micro-jets and acoustic streaming. These effects (i) shear incoming hydrogen bubbles into much smaller daughter bubbles, (ii) thin the diffusion boundary layer at the liquid-gas interface, and (iii) set up steady micro-vortices that recirculate the bulk liquid. Because cavitation threshold varies with temperature and dissolved-gas content, the drive circuit can PWM-modulate burst length to keep the transducer within safe limits while maximizing dissolution.

### Low-Frequency Mixing (≈50 Hz- 1 kHz).

In an alternative mode the transducer—or a dedicated miniature voice-coil speaker—operates well below ultrasonic frequencies, producing large-amplitude, slow pressure oscillations that behave like a “sonic piston.” These pressure swings induce bulk sloshing and standing-wave nodes that displace the water column back and forth. Large hydrogen bubbles injected from the valve are repeatedly accelerated and decelerated, stretching and fragmenting as they encounter alternating high-and low-pressure zones. The motion also prevents stratification, keeps the entire volume in gentle circulation, and can be tuned (via frequency sweeps or amplitude ramps) to avoid resonance with the bottle structure.

Both regimes may be combined in a dual-band driver: a brief ultrasonic burst is triggered immediately after each one-way-valve event to shatter the freshly released hydrogen bubble, followed by a lower-frequency maintenance pulse train that keeps the solution homogenous until the next gas charge. Because the transducer has no rotating parts and is sealed behind the bottle wall, the acoustic-mix embodiment yields a slim, fully enclosed base, eliminates mechanical wear, and operates virtually silently at ultrasonic settings—advantages that are especially valuable for premium consumer units where form factor and noise are critical.

Power demand is modest (typically 1-2 W peak for ultrasonic bursts and <0.5 W RMS for low-frequency sloshing), and firmware can adapt duty cycle to battery state-of-charge or user-selected “rapid infuse” modes. Optional feedback from an accelerometer or hydrophone inside the cavity can confirm that acoustic energy is coupling effectively, allowing closed-loop adjustment of drive amplitude for different fill levels or water chemistries. In this way, acoustic mixing provides a versatile, contact-free alternative to impellers and other mechanical mixers while still achieving fast, uniform hydrogen dissolution and preserving the contamination barrier established by the one-way valve.

In another variant, active mixing and enhanced hydrogen uptake are achieved with a miniature pump rather than with mechanical stirrers or acoustic drivers. A compact, sealed liquid-circulation pump 760 is mounted at the base or sidewall of the drinking-water chamber. The pump draws water through an inlet port 762a located near the region where hydrogen bubbles enter and discharges it through an outlet port 762b positioned several centimeters away—typically higher in the column or on an opposite wall. This forced recirculation establishes a continuous loop that sweeps large bubbles away from the outlet of the one-way valve 202, breaks them up through shear as they traverse the flow path, and delivers well-mixed, hydrogen-rich water to every part of the vessel. Flow rate can be modulated by PWM-driving the pump's DC motor or piezoelectric diaphragm; the controller ramps to a higher setting immediately after each valve event, then idles at a lower maintenance speed to minimize power draw.

A second, complementary approach employs a gas-injection pump 764—for example, a micro-blower or diaphragm pump—dedicated to harvesting hydrogen that accumulates in the headspace above the liquid and re-injecting it into the water. A short pickup tube taps the headspace, while a delivery tube 766 carries the gas downward to a diffuser situated near the vessel bottom. The diffuser may be a porous stone, a sintered polymer tip, or a section of bamboo fiber, the latter chosen for its natural micro-channeled structure that spontaneously wicks water and encourages fine-bubble formation. During each injection cycle the pump runs just long enough to push a metered bolus of head-space gas through the diffuser, producing a plume of micro-bubbles that rise slowly and dissolve almost completely before reaching the surface. A check valve in the pickup line prevents back-flow of liquid when the pump is off, while a miniature pressure sensor can confirm that headspace pressure remains within safe limits.

Either pump configuration may be used alone or in tandem. For instance, a bottle designed for rapid dosing might combine continuous low-speed water recirculation with periodic headspace scavenging: firmware monitors dissolved-hydrogen concentration (via an optional electrochemical sensor) and triggers additional gas-injection bursts whenever the concentration drifts below a target threshold. Because the pumps and tubing are isolated from the hydrogen-generation compartment—gas crosses the one-way valve 202 only in clean form—the contamination barrier of earlier embodiments is preserved. Moreover, the modular pump assemblies fit neatly into cavities molded into the bottle shell, allowing designers to trade off battery capacity, sensor payload, or aesthetics without altering the fundamental electrolysis path.

By providing directed fluid flow and, when desired, headspace recycling, the pump-based embodiment delivers rapid, uniform hydrogen dissolution while offering flexible control over mixing intensity, acoustic profile, and power consumption—advantages that can be tailored to both premium and cost-sensitive product lines.

It should be understood that the various mixing and agitation techniques disclosed herein—including, but not limited to, central or offset impellers, magnetic stir bars, oscillating or reciprocating paddles, ultrasonic or low-frequency acoustic transducers, liquid-circulation pumps, and head-space gas-injection pumps—may be implemented individually or in any practical combination with one another to achieve the desired rate of hydrogen dissolution. The specific examples are presented for illustrative purposes only; interchangeable, sequential, or concurrent use of two or more of these mechanisms falls squarely within the contemplated scope of the invention. Moreover, although the specification frequently refers to “drinking water” for clarity, the term is intended to encompass any potable liquid—including flavored waters, sports drinks, teas, juices, or other beverages—into which molecular hydrogen may be infused for consumption.

The embodiments set forth in this description are illustrative in nature only and are not intended to limit the scope of the invention; rather, they demonstrate representative implementations that apply the underlying principles of contaminant separation, bubble management, and accelerated hydrogen dissolution. Other configurations consistent with these principles—including alternative placements, orientations, or integrations of the hydrogen-generation components and mixing mechanisms—are fully encompassed within this disclosure. By way of example, the mixing system, the electrolysis unit, or both may be located in an upper compartment of the bottle, or certain elements (such as an ultrasonic transducer) may reside in the top section while other elements (such as a circulation pump or magnetic stir bar) remain in the bottom, provided the overall arrangement maintains the functional relationships described herein.

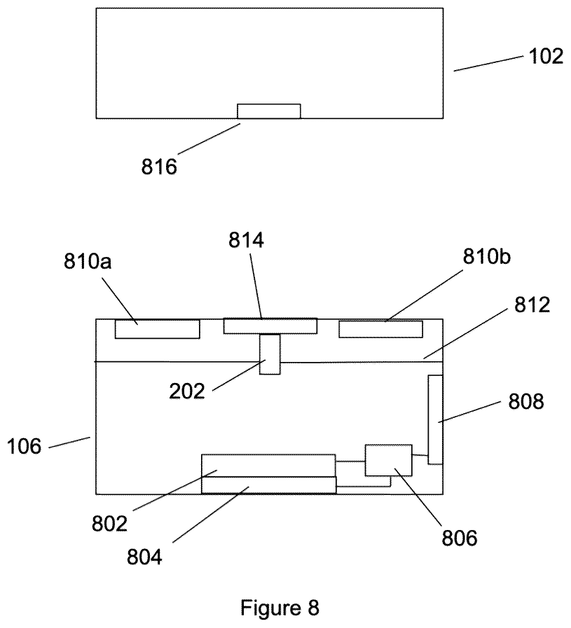

FIG. 8 illustrates a hydrogen generation compartment 106 in accordance with the principles of the present inventions. The hydrogen generation compartment 106 may be separated into two or more compartments. Separation wall 812 separates the water used for the hydrogen production, in the lower section, from the hydrogen gas in the upper section. Pressure valve 202 operates to open when a certain pressure of hydrogen develops in the lower section and then closes once the pressure is released (e.g., a mechanical valve, an electromechanical valve with sensor feedback). The released pressure may be produced as large bubbles. The pressure valve 202 may open to a mesh material. The space between the valve and the mesh may build pressure until it is high enough to pass through the membrane, which may generate smaller bubbles of hydrogen.

FIG. 6 also illustrates an electronic electrolysis system 802 powered by battery 804 and controlled by processor 806. The processor 806 may control the electrolysis process based on factors such as pressure, amount of water in the compartment 106, sensor feedback, cleanliness of the chamber 106, condition of the electrolysis system 802, time of use (e.g., aggregate time in use, time in use in a current process, time of day, drinking schedule, power requirements (e.g., a need for higher hydrogen production rate), etc.

The processor 806 may also operate a computer screen and user interfaces 808. The computer screen and user interfaces 808 may provide a user with information concerning the condition of the system (e.g., cleanliness, wear, time to drink, expiration of time to drink based on an estimated hydrogen leakage). It may also provide the user with control features (e.g., how long to generate hydrogen). The computer screen and user interfaces 808 may also provide other control or feedback.

Another aspect of the present invention relates to exposing the drinkable water to various frequencies of energy, magnetism, etc. The water bottle may have an electromagnetic frequency generator, magnets, etc. in the top 102, bottom 106, or elsewhere. For example, FIG. 6 illustrates a frequency generator 816 in the top 102 and magnets 810a and 810b in the bottom 106. In embodiments, separating the frequency generation at the top and the magnets at the bottom is meant to simulate an earth like condition for the water. The magnets representing earth ground and the frequencies representing the atmosphere. The electromagnetic frequency generator may produce visible light, infrared, ultraviolet, or other frequencies further away from the visible. The frequency of may change over time (e.g., to simulate a daytime cycle) or based on a desired condition (e.g., a user want calming energy, energizing energy, focusing energy). If visible light is produced, it may change color over time (e.g., to simulate a day cycle) or based on a sensed condition (e.g., temperature, water quality). Ultraviolet may be produced to clean the water and/or the bottle.

In embodiments, a frequency generator may be included and product ultrasound or acoustic energy (e.g., kHz to MHz) directed into the water within the container. For example, the system may generate 20 kHz- 3 MHz energy and direct it into the water. This may have the effect of cavitation, which can create nanobubbles, which can trap hydrogen gas more effectively. Frequencies in the ~100 kHz-500 kHz range have been found efficient for forming stable micro-and nanobubbles. This may “structure” the hydrogen water in a practical sense—keeping H₂ dissolved longer.

Another aspect of the present inventions relates to communication connectivity of the water bottle. The processor 606 may also communicate data to and from the bottle 100 (e.g., through Bluetooth®, WiFi or wires). The data may provide feedback to the user about conditions of the bottle systems, conditions of the water in the generating compartment 106, conditions of the drinkable water, etc. Another processor in another device (e.g., phone, desktop, laptop) may be connected to the processor 606 to provide the user feedback and allow the user to control features of the bottle 100.

While embodiments may refer to hydrogen infused water, it should be understood that the inventions herein relate to hydrogen infused drinkable fluids in general. For example, one might use the systems and methods described herein to infuse hydrogen into juice, milk, energy drinks, water, sports drinks, etc.

It will be appreciated that the present invention has been described herein with reference to certain exemplary embodiments, which are intended to be illustrative rather than limiting. Various modifications, additions, and substitutions will be apparent to those skilled in the art without departing from the spirit and scope of the invention. The invention encompasses hardware implementations, software implementations, as well as combinations thereof. In particular, the disclosed subject matter may be embodied as systems comprising physical components, as methods executed in whole or in part by one or more processors, or as non-transitory computer-readable media encoding instructions that, when executed, carry out the disclosed processes. Accordingly, the scope of the invention should be determined not with reference to the above description, but instead with reference to the appended claims along with their full range of equivalents.

1. A hydrogen-infusing drinking container comprising:
a vessel defining a drinking-fluid chamber configured to hold a potable liquid;
a hydrogen infusion system arranged to introduce hydrogen into the drinking-fluid chamber;
an electromagnetic frequency generator positioned to direct non-visible electromagnetic energy into the drinking-fluid chamber; and
at least one magnet positioned relative to the vessel to establish a magnetic field through the drinking-fluid chamber,
wherein the electromagnetic frequency generator and the magnet are arranged to simulate natural environmental conditions for the potable liquid while promoting stability and dissolution of the introduced hydrogen.

2. The container of claim 1, wherein the electromagnetic frequency generator is configured to produce infrared energy.

3. The container of claim 1, wherein the electromagnetic frequency generator is configured to produce ultraviolet energy.

4. The container of claim 1, wherein the electromagnetic frequency generator outputs acoustic energy to induce cavitation and form nanobubbles that retain hydrogen within the potable liquid.

5. The container of claim 4, wherein the acoustic energy is ultrasonic energy between about 20 kHz and 1 MHz.

6. The container of claim 1, wherein the electromagnetic frequency generator varies frequency output over time to simulate a natural environmental cycle.

7. The container of claim 1, wherein the magnet is positioned adjacent a base of the vessel to simulate an earth-ground condition, and the electromagnetic frequency generator is positioned adjacent a top portion of the vessel to simulate atmospheric exposure.

8. The container of claim 1, wherein the hydrogen infusion system comprises a hydrogen source selected from the group consisting of an electrolysis cell, a reactive metal element, a metal hydride, or a compressed hydrogen cartridge.

9. The container of claim 1, wherein the vessel further comprises a dissolved-hydrogen concentration sensor operatively coupled to control circuitry that adjusts the output of the electromagnetic frequency generator based on sensor feedback.

10. The container of claim 1, wherein the vessel further comprises a user interface configured to allow selection among different electromagnetic frequency modes corresponding to calming, energizing, or focusing conditions.

11. A method of conditioning hydrogen-infused drinking water, the method comprising:
operating a hydrogen infusion system to introduce hydrogen into a drinking-fluid chamber of a vessel;
applying non-visible electromagnetic energy from a generator into the drinking-fluid chamber; and
exposing the drinking-fluid chamber to a magnetic field established by at least one magnet,
wherein the electromagnetic energy and the magnetic field cooperate to simulate natural environmental conditions for the potable liquid while promoting stability and dissolution of the introduced hydrogen.

12. The method of claim 11, wherein applying non-visible electromagnetic energy comprises producing infrared energy.

13. The method of claim 11, wherein applying non-visible electromagnetic energy comprises producing ultraviolet energy.

14. The method of claim 11, wherein applying non-visible electromagnetic energy comprises generating ultrasonic acoustic energy between about 20 kHz and 1 MHz to induce cavitation and nanobubble formation.

15. The method of claim 11, further comprising varying the electromagnetic frequency output over time to simulate a diurnal cycle.
